(19) United States
(12) Patent Application Publication
(10) Pub. No.: US 2010/0061518 A1
(43) Pub. Date: Mar. 11, 2010

(54) MINIATURIZED SOURCE OF IONIZING ELECTROMAGNETIC RADIATION

(75) Inventor: Leif SMITH, Uppsala (SE)

Correspondence Address: FOLEY AND LARDNER LLP;SUITE 500, 3000 K STREET NW, WASHINGTON, DC, 20007, US

(73) Assignee: RADI MEDICAL TECHNOLOGY AB

(21) Appl. No.: 12/208,018

(22) Filed: Sep. 10, 2008

(51) Int. Cl. H01J 35/18

(52) U.S. Cl. 378/140

(57) ABSTRACT

The invention is directed to a miniaturized source (10; 20; 40; 80) of ionizing electromagnetic radiation, comprising a first electrode (11; 21; 41, 42; 81), which at least temporarily can function as a cathode, and a second electrode (12; 22; 43, 44, 45; 82), which at least temporarily can function as an anode, a first conductor (13; 23; 46, 47; 83) connected to the first electrode, and a second conductor (14; 24; 48, 49, 50; 84) connected to the second electrode. According to one embodiment, the first electrode and at least a portion of the first conductor are provided on a substrate (15; 10 25; 51; 85). According to another embodiment, also the second electrode and at least a portion of the second conductor are provided on the substrate. In all embodiments, the electrodes are arranged such that the electric field between the electrodes essentially is parallel to the surface of the substrate.

### FIELD OF THE INVENTION

The present invention relates generally to the generation of X-rays for medical purposes, and in particular to a miniaturized X-ray source arranged on a substrate.

### BACKGROUND OF THE INVENTION

The generation of X-rays is typically achieved by employing X-ray tubes. This type of X-ray source is, however, less suited for medical device applications, where the X-ray source is introduced into a patient's body.

Miniaturized X-ray sources for medical radiation treatments have been previously suggested. In U.S. Pat. No. 6,241,651, which is assigned to the present assignee, a miniaturized X-ray source is disclosed, which comprises a cathode and an anode in various arrangements. The U.S. Pat. No. 6,477,233, which is assigned to the present assignee, discloses that an anode and a cathode can be arranged opposite each other in a common chip; and U.S. Pat. No. 6,623,418, which also is assigned to the present assignee, shows a conventional X-ray chip (for example, in FIG. 4) and how such conventional chips can be arranged on a support, on which electrical leads have been patterned (for example, in FIG. 2a). The entire contents of the above-mentioned patents are incorporated by reference herein for the X-ray devices and methods disclosed therein.

### SUMMARY OF THE INVENTION

The X-ray sources described in the patents mentioned above are, however, not without drawbacks. Experience has shown that a commercially acceptable production of these X-ray sources faces various practical problems when it comes to, for example, electrically contacting the electrodes, producing sufficient vacuum in the cavity accommodating the electrodes, and providing a sufficient insulation distance between the electrodes.

The present invention is therefore directed to an improved miniaturized X-ray source, with which the above-mentioned problems are eliminated or at least minimized.

An embodiment of a miniaturized X-ray source according to the present invention comprises a first electrode functioning as a cathode, a second electrode functioning as an anode, a first conductor electrically connected to the first electrode, and a second conductor electrically connected to the second electrode, wherein the first and second electrodes as well as the first and second conductors all are arranged on a common substrate. With this design, electrical contacting of the electrodes is facilitated in comparison with an arrangement where the electrodes are located on top of each other. Also, the distance (i.e. the insulation distance) between the electrodes is practically infinitely variable.

In another embodiment only a first electrode, which functions as a cathode, and a conductor connected to this electrode is provided on (for example, provided directly on, or formed directly on) a substrate, whereas a second electrode, which functions as an anode, is arranged outside the substrate. The second electrode is, however, essentially positioned in the same plane as the substrate, such that the electric field also in this case is directed along the surface of the substrate.

Other embodiments of the invention comprise at least one further electrode, which functions as a so-called gate. Also such a gate is disposed on the same substrate that accommodates the other electrodes, something which, for example, facilitates production of a miniaturized X-ray source. Further, by providing the electrodes, and in particular electrodes functioning as cathodes and/or gates as well as their conductors on a substrate, a higher degree of accuracy can be obtained regarding the positioning of the electrodes and conductors in comparison with known methods. Thereby a more reliable and accurate X-ray source can be provided.

To work properly as an X-ray source, the electrodes have to be encapsulated in a vacuum atmosphere. With the electrodes provided on a common substrate, at least a portion of this substrate can be enclosed in some sort of encapsulation. Such an encapsulation can be provided as a housing arranged on one side of the substrate, or the encapsulation can be provided as a casing which surrounds all sides of the substrate at a portion thereof. In contrast to the prior art, where the vacuum cavity can be regarded as an integrated part of the X-ray source, the vacuum encapsulation can thereby be provided separately from the actual electrode arrangement, which provides for a better and more reliable vacuum atmosphere. By providing the substrate with a so-called getter, a reactive material which can absorb or adsorb remaining traces of gas, an improved vacuum atmosphere can be maintained.

The invention may be applied to and used in all types of medical devices, such as for example, guidewires, catheters, sources and instruments for brachytherapy, and the devices discussed in the three patents discussed above.

### BRIEF DESCRIPTION OF THE DRAWINGS

FIG. 1 illustrates schematically a miniaturized X-ray source comprising a cathode, an anode and electrical conductors, all provided on a substrate, according to a first embodiment of the present invention.

FIG. 2 illustrates a second embodiment of an X-ray source according to the present invention, which further is provided with a gate and a getter.

FIG. 3 illustrates a third embodiment of an X-ray source according to the present invention, which comprises more than one cathode and more than one anode.

FIG. 4 shows schematically a miniaturized X-ray source, which is provided with a vacuum encapsulation according to a fourth embodiment of the present invention.

FIG. 5 shows schematically a miniaturized X-ray source, which is provided with a vacuum encapsulation according to a fifth embodiment of the present invention.

FIG. 6 illustrates schematically a miniaturized X-ray source comprising a cathode and a conductor, which are provided on a substrate, and an anode arranged outside the substrate, according to a sixth embodiment of the present invention.

### DETAILED DESCRIPTION OF PREFERRED EMBODIMENTS

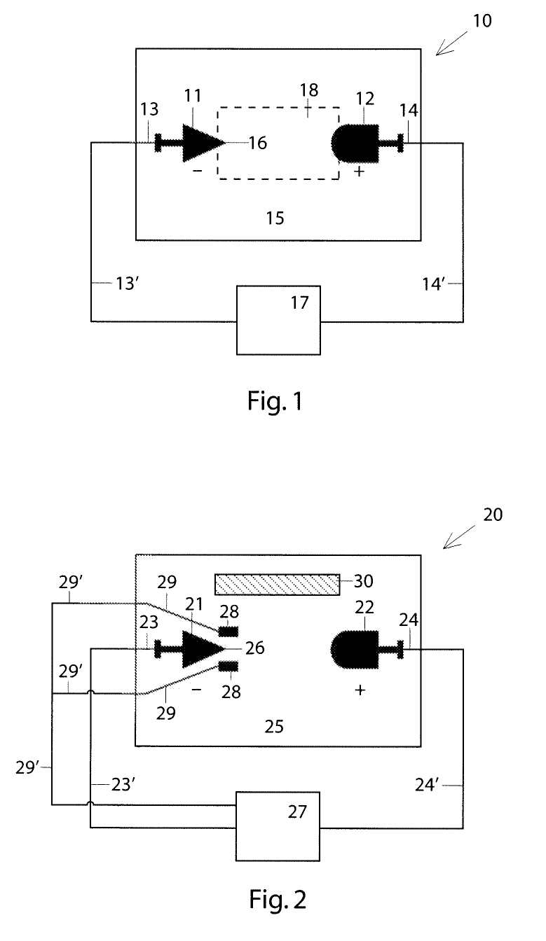

A first embodiment of a miniaturized X-ray source 10 according to the present invention is schematically illustrated in FIG. 1. As shown, the X-ray source 10 comprises a first electrode 11, a second electrode 12, a first conductor 13, and a second conductor 14. The first electrode 11, the second electrode 12, at least a portion of the first conductor 13, and at least a portion of the second conductor 14 are arranged on a common substrate 15. In this embodiment, the electrodes 11, 12 and conductors 13, 14 are in contact with substrate 15. The substrate is sized for insertion or implantation in a human body. The substrate may, for example, have a largest dimension smaller than 10 mm, or smaller than 5 mm, or smaller than 1 mm. The first electrode 11 has, in this embodiment, the shape of a triangle with a sharp tip 16; and if electric voltage is applied between the first electrode 11 and the second electrode 12, the electrical field strength will be extremely high at the tip 16. A positive voltage on the second electrode 12 will cause electrons to be emitted from the first electrode 11 by the phenomenon known as field emission. Clearly, the first electrode 11 will thereby function as a cathode 11 and the second electrode 12 will function as an anode 12. The electrons emitted from the cathode 11 are accelerated by the electric field until they are retarded by the impact at the anode 12. The retardation of the electrons causes electromagnetic radiation to be emitted. The primary radiation, which is called bremsstrahlung, has a continuous spectrum with a peak corresponding to a given fraction of the electron energy. Thus, by varying the strength of the applied electric field, the energy of the electrons emitted from the cathode and thereby the position of the bremsstrahlung peak can be varied. In embodiments of the present invention, the strength, duration and other parameters of the applied electrical voltage are controlled by a control unit 17. The control unit 17 is connected to the first conductor 13 and to the second conductor 14 by further conductors 13′ and 14′, respectively. These further conductors 13′ and 14′ are not part of the X-ray source itself, but instead further conductors 13′ and 14′ connect the X-ray source itself to the control unit(s). To allow the emitted electrons to more freely move laterally along the board 15, and to absorb less of the generated radiation, a recess or window can be provided in the substrate 15. That is, some of the material or all of the material can be removed from a portion of the substrate. Such a recess or window portion can have any suitable shape, and has in FIG. 1 only been schematically indicated by dashed lines and is denoted by reference numeral 18. As an alternative or complement, at least one of the electrodes, and in particular the electrode functioning as a cathode, can have a certain height above the upper surface of a substrate, such that the electrons are emitted from a location which is somewhat elevated from the upper surface of the substrate in order to create a free way for the electrodes from the cathode to the anode. In all embodiments presented herein it is assumed that the electrode arrangement is such that the emitted electrodes, or at least a sufficiently large portion of the emitted electrodes, have a free way from the cathode to the anode.

As an alternative to the field emission type of cathode described above, a cathode could be a thermo-resistive emission type of cathode, which, when heated to high temperatures, gives rise to thermal emission of electrons. A still further alternative is to generate electrons by means of a ferroelectric type of cathode, i.e. a cathode made from a ferroelectric material.

The anode is preferably made from a metal having a high atomic weight, corresponding to an atomic number exceeding 50. The anode can, for example, be made from tungsten, cobalt, molybdenum, or aluminium. The cathode can preferably comprise a thin film of a material having a low work function, i.e. the minimum energy required for an electron to be emitted from the surface into the ambient. Examples of materials with this property are oxides of metals from Groups I and II in the periodic system, including caesium, barium, and magnesium. In FIG. 1, the anode has been given a rounded shape, to efficiently collect the electrons emitted from the cathode while still allowing photons (X-rays) to be emitted from the surface. Other shapes of the cathode and anode are however possible; and with suitable choices of shapes for the anode and cathode it is possible to let the anode and cathode switch, i.e. periodically the first electrode can function as an anode or a cathode, while the second electrode functions as a cathode or an anode. Such a switching function is controlled by the control unit.

Now returning to FIG. 1, where it should be noted that in contrast to the arrangement disclosed in, for example, the above-mentioned U.S. Pat. No. 6,623,418, the first and second electrodes are provided laterally and directly on the surface of the substrate 15 such that the electrons essentially move along and parallel to this surface. The substrate 15 is consequently part of the miniaturized X-ray source 10 rather than being merely a carrier or holder for one or several separate X-ray chips, as suggested in the U.S. Pat. No. 6,623,418.

The substrate 15 is preferably an insulator, i.e. made from an electrically non-conductive material. The substrate 15 can be a board of a suitable material such as polyimide/kapton, epoxy, composite or ceramic materials, or other materials well-known from the field of printed circuit boards. In fact, the electrodes as well as the conductors can be created by techniques which are utilized in the production of printed circuit boards, e.g. standard photo-lithographic techniques; and an X-ray source according to the present invention may be denoted as a printed circuit X-ray source. Such techniques allow the electrodes as well as the conductors to be very thin and lie almost in the same plane as the top of the substrate, for particular applications. Preferably, the substrate has a high thermal conductivity, to lead away heat generated by the electron current. The substrate could for example be made from sapphire.

Rather then pattern both of the conductors 13 and 14 on the common substrate 15, it is also contemplated that only a portion of one of the conductors 13, 14 is patterned on the substrate 15, whereas the other conductor is provided as, for example, an electrical lead or cable. Further, rather than provide one or both of the electrodes 11 and 12 as a conductive pattern on a non-conductive board, it is further within the scope of the present invention to only provide a position indication, e.g. in the form of a bore or a pin, for the cathode 11 and/or anode 12 on the substrate 15. In a fixed spatial relation to such a position indication, an electrode can then be formed by fastening, e.g. by soldering or gluing, a geometrical structure on the substrate. Such a geometrical structure can be a small plate having the desired shape, e.g. the shapes indicated in FIG. 1 for the cathode 11 and anode 12, respectively. It is further possible to use a combination of an extra geometrical structure or member and a patterning technique when it comes to form an electrode. As an example, the very tip 16 of the cathode 11 can be provided as a very small triangular plate, whereas the base of the cathode triangle is patterned in the substrate 15.

FIG. 2 illustrates schematically a second embodiment of a miniaturized X-ray source 20 according to the present invention. Like the first embodiment presented in FIG. 1, the X-ray source 20 comprises a first electrode 21, which at least temporarily can function as a cathode 21, a second electrode 22, which at least temporarily can function as an anode 22, a first conductor 23 electrically connected to the first electrode 21, and a second conductor 24 electrically connected to the second electrode 22. The first and second electrodes 21, 22 as well as at least a portion of the first conductor 23 and/or the second conductor 24 are provided on a common substrate 25. In this embodiment, the X-ray source 20 comprises further a third electrode 28, which can function as a gate 28. The gate 28 controls the electron current emitted towards the anode 22. The gate 28 is provided with at least one separate conductor 29, enabling a separate voltage to be applied to the gate 28. According to the well-known theory of vacuum tubes, the anode current is controlled by the gate voltage. This will directly influence the intensity of the emitted radiation, which is approximately proportional to the anode current. The emitted dose is simply the time integral of this intensity. By separate and independent control of the gate and anode voltages, it is thus possible to independently control the emitted dose and energy, respectively. In this second embodiment, all voltages are controlled by a control unit 27. The control unit 27 is connected to the first conductor 23 and to the second conductor 24, by further conductors 23′ and 24′, respectively. If an X-ray source is to be run in an alternating mode, where two electrodes alternating function as cathode and anode, another gate could be provided at the second electrode 22. In general, any desired number of gates having any desired configurations can be arranged on a common substrate.

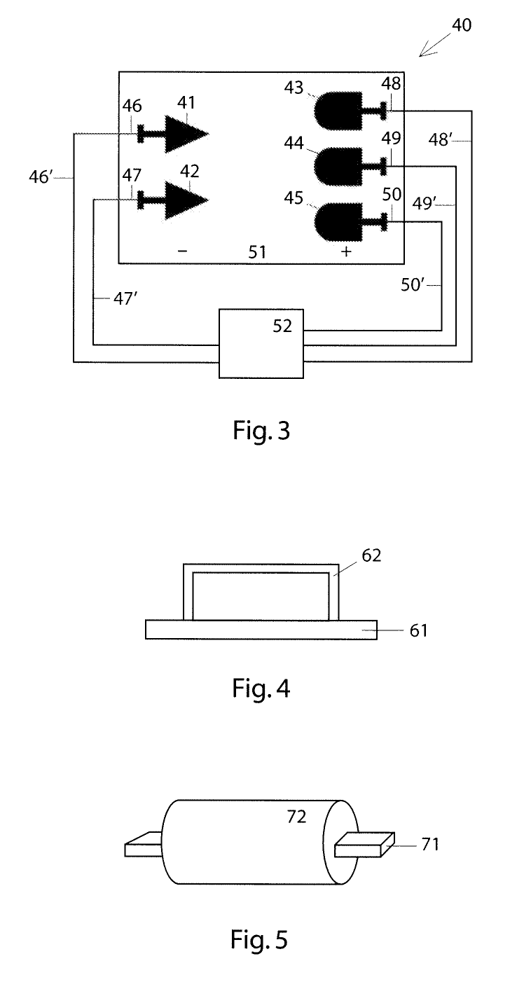

As can be appreciated from the description above, an X-ray source which is arranged on a substrate provides for a large versatility. It is, for example, easy to arrange two or more electrodes, which at least temporarily function as cathodes, and/or two or more electrodes, which at least temporarily function as anodes, on a common substrate. Such a configuration is shown in FIG. 3, where an X-ray source 40 comprises a first set of two electrodes 41 and 42, which at least temporarily function as cathodes 41, 42, and a second set of three electrodes 43, 44 and 45, which at least temporarily function as anodes 43, 44, 45. Like before, conductors 46-50, or portions thereof, have together with the electrodes 41-45 been provided on a common substrate 51. The substrate could further be provided with one or several gates and/or one or several recess(es) or window(s), as have been explained above. The electrodes 41-45 as well as any extra gates are provided with separate voltages under control of a control unit 52 (connected by further conductors 46′, 47′, 48′, 49′, and 50′), which, at a given time, also controls whether one or both of the cathodes 41 and 42 function as cathode and whether one, two or all of the anodes 43-45 function as anode. Generally, by providing more than two electrodes, an improved heat and dosage control is achieved.

As stated above, an X-ray source has to operate in vacuum, and examples of how a suitable vacuum atmosphere can be created for an X-ray source according to the present invention are discussed below in conjunction with FIGS. 4 and 5. Here it should be noted that a substrate-based miniaturized X-ray source can be supplemented with a so-called gettering material or getter, which in FIG. 2 has been denoted by the reference numeral 30. A getter is generally a reactive material used for removing traces of gas from vacuum systems. Suitable getter materials for the present X-ray source can be barium, aluminium, magnesium, calcium, sodium, strontium, caesium, or phosphorus. As indicated in FIG. 2, a getter 30 has in the form of a strip 30 been applied to the substrate 25. Suitable getters can also be provided to the embodiments shown in FIG. 1 and FIG. 3, respectively.

FIG. 4 and FIG. 5 illustrate two different ways of creating a vacuum atmosphere for a miniaturized X-ray source according to the present invention. More particularly, FIG. 4 shows how a substrate 61, which is similar to the substrates described in conjunction with FIG. 1, FIG. 2 and FIG. 3, respectively, can be provided with an encapsulation in the form of a housing 62, which is provided on one side of the substrate 61 to cover at least the anode and cathode (not shown in FIG. 4), which in accordance with the description above have been arranged on the surface of the substrate 61.

FIG. 5 discloses another way of creating a vacuum atmosphere for an X-ray source according to the invention. Here, a substrate 71 has been provided with an encapsulation in the form of a tubular casing 72, which surrounds and encloses a portion of the substrate 71; that is, the casing 72 encloses at least the anode and cathode (not shown in FIG. 5), which in accordance with the description above have been arranged on the surface of the substrate 71. A casing could, as an alternative, enclose the whole substrate such that only the conductors penetrate through the end surfaces of the casing.

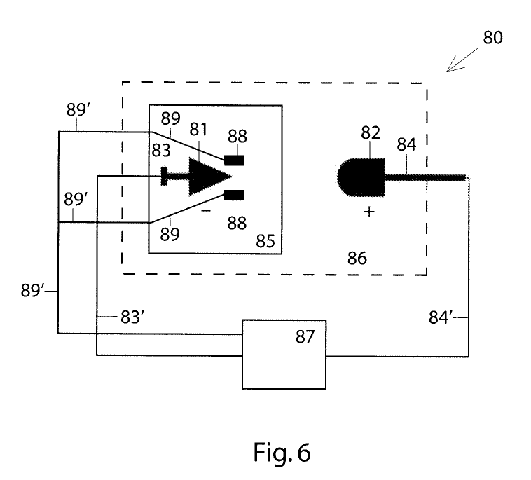

As already indicated, to provide a reliable, accurate and easily controllable miniaturized X-ray source, the positioning of the electrodes is a crucial parameter. By arranging the electrodes on a substrate, the desired accuracy can, for example, be achieved by methods well-known in the field of printed circuit boards. For example, the relative distance between a cathode and a gate can be determined within the order of micrometers (μm). Also the conductors belonging to these electrodes can be created with high accuracy. Here, it should be noted that the position(s) and shape of a cathode, and in particular its tip, and (if present) a gate are far more crucial than the position of the corresponding anode. In line with these findings, a sixth embodiment of the invention is illustrated in FIG. 6, where a miniaturized X-ray source 80 comprises a first electrode 81, which at least temporarily functions as a cathode 81, and a first conductor 83 connected to the first electrode 81. The first electrode 81 and at least a portion of the first conductor 83 are provided on a substrate 85. In this embodiment, a gate electrode 88 and at least a portion of a conductor 89 electrically connected to the gate 88 are also provided on the substrate 85. Such a gate is, however, not mandatory for practising the present invention. The X-ray source 80 comprises further a second electrode 82, which at least temporarily functions as an anode 82, and a second conductor 84 electrically connected to the second electrode 82. The second electrode 82 is disposed outside the substrate 85, but is essentially arranged in the same plane as the substrate 85. The electrical field created between the anode 82 and the cathode 81, or between the anode 82 and the gate 88, is consequently essentially directed along the surface of the substrate 85, such that the majority of the electrons emitted from the cathode travel parallel to the plane of the substrate 85. In this embodiment, the conductor 84 functions also as a holder or support for the anode 82, but a separate holder/support can instead be provided for the anode 82. The electrodes 81, 82, 88 are encapsulated in a vacuum encapsulation 86, schematically indicated with dashed lines in FIG. 6. The vacuum encapsulation 86 can be provided in the form of a tubular casing 86, similar to the tubular casing 72 shown in FIG. 5 above. The operation of the electrodes 81, 82, 88 is preferably individually controlled by a control unit 87 (connected by further conductors 83′, 84′, and 89′).

For all embodiments shown herein, it should be noted that all electrodes are provided laterally and directly on the surface of a substrate such that the emitted electrons essentially move along and parallel to this surface; or stated differently, the electrodes are arranged such that the electric field between the electrodes essentially is parallel to the surface of the substrate. It should further be noted that an electrode operating as a cathode in practise also can be provided with multiple tips, such that electrons emitted from this electrode actually emanate from more than one tip, or are emitted from the tip where the field strength is highest, usually the sharpest tip. In contrast to the embodiment shown and discussed in conjunction with FIG. 3, such multiple cathode tips are not separately controllable by a control unit.

Although the present invention has been described with reference to specific embodiments, also shown in the appended drawings, it will be apparent to those skilled in the art that many variations and modifications can be done within the scope of the invention as described in the specification and defined with reference to the claims below. For example, multiple X-ray sources (such as sources 10, 20, or 40) can be arranged on a support as described in the '418 patent cited above.

What is claimed is:

1. A miniaturized source of ionizing electromagnetic radiation, comprising a first electrode, which at least temporarily can function as a cathode, and a second electrode, which at least temporarily can function as an anode, a first conductor connected to the first electrode, and a second conductor connected to the second electrode, wherein the first electrode as well as at least a portion of the first conductor are provided directly on a substrate.

2. The miniaturized source according to claim 1, wherein the second electrode is arranged outside of the substrate, and is essentially arranged in the same plane as the substrate.

3. The miniaturized source according to claim 2, wherein the first electrode and the second electrode are encapsulated in a common vacuum.

4. The miniaturized source according to claim 1, wherein the second electrode and at least a portion of the second conductor are provided on the substrate.

5. The miniaturized source according to claim 4, wherein the substrate is in the form of a non-conductive board.

6. The miniaturized source according to claim 5, wherein at least one of the first and second conductors is in the form of a conductive pathway patterned on the non-conductive board.

7. The miniaturized source according to claim 5, wherein at least one of the first and second electrodes is patterned on the non-conductive board.

8. The miniaturized source according to claim 5, wherein the non-conductive board comprises at least one position indication for at least one of the first and second electrodes.

9. The miniaturized source according to claim 8, wherein at least one of the first and second electrodes is in the form of at least one geometrical structure, which is arranged in a fixed relation to the at least one position indication.

10. The miniaturized source according to claim 5, wherein at least one of the first and second electrodes is partly patterned on the non-conductive board and is partly provided as at least one geometrical structure.

11. The miniaturized source according to claim 1, wherein the miniaturized source further comprises at least one gate, which is provided on the common substrate.

12. The miniaturized source according to claim 5, wherein at least one gate is patterned on the non-conductive board.

13. The miniaturized source according to claim 12, wherein the non-conductive board comprises at least one position indication for the at least one gate.

14. The miniaturized source according to claim 13, wherein the at least one gate is in the form of at least one geometrical structure, which is arranged in a fixed relation to the at least one position indication.

15. The miniaturized source according to claim 12, wherein the at least one gate is partly patterned on the non-conductive board and is partly provided as at least one geometrical structure.

16. The miniaturized source according to claim 1, wherein at least a portion of the substrate is encapsulated in a vacuum.

17. The miniaturized source according to claim 16, wherein the encapsulated portion further contains a gettering material.

18. The miniaturized source according to claim 1, wherein the substrate is provided with a recess or window proximate at least one of the first electrode and the second electrode.

19. The miniaturized source according to claim 1, wherein more than two electrodes, which at least temporarily can function as cathodes, are provided on the substrate.

20. The miniaturized source according to claim 1, wherein more than two electrodes, which at least temporarily can function as anodes, are provided on the substrate.

21. The miniaturized source according to claim 5, wherein the non-conductive board is a printed circuit board.

22. The miniaturized source according to claim 5, wherein the substrate is a thermal conductive board.

23. A miniaturized source of ionizing electromagnetic radiation, comprising a first electrode, which at least temporarily can function as a cathode, and a second electrode, which at least temporarily can function as an anode, wherein the first and second electrodes are configured to emit X-rays and wherein the first and second electrodes lie in substantially the same plane.
